(19) United States
(12) Patent Application Publication
(10) Pub. No.: US 2008/0021674 A1
(43) Pub. Date: Jan. 24, 2008

(54) Methods for Enhancing the Analysis of Particle Detection

(76) Inventor: Robert Puskas, Manchester, MO (US)

Correspondence Address: WILSON SONSINI GOODRICH & ROSATI, 650 PAGE MILL ROAD, PALO ALTO, CA, 94304-1050, US

(21) Appl. No.: 10/574,055

(22) PCT Filed: Sep. 30, 2004
(86) PCT No.: PCT/US04/32244

§ 371 Date: Apr. 6, 2007

Related U.S. Application Data
(60) Provisional application No. 60/507,243, filed on Sep. 30, 2003.

(51) Int. Cl. G06F 15/00

(52) U.S. Cl. 702/179

(57) ABSTRACT

Methods for enhancing the analysis of particle detection are provided comprising measuring a first electromagnetic radiation signal provided by a particle, comparing by cross-correlation the electromagnetic radiation signal emitted by the particle, and further applying an analytical filter to the cross-correlation events, thereby enhancing the analysis of the particle emission.

### CROSS-REFERENCE TO RELATED APPLICATIONS

This application claims priority from U.S. Provisional Application Ser. No. 60/507,243 filed on Sep. 30, 2003, which is incorporated herein by reference in its entirety.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The invention relates generally to detection and discrimination of individual particles at ultra-low concentrations in a flowing solution. Electromagnetic emission from the particles is detected as they move into two interrogation volumes and the data collected by detectors at each interrogation volume is analyzed by cross-correlation and application of analytical filters to distinguish particle signals from background.

2. Description of Related Art

Techniques for detecting lower and lower concentrations of biological molecules are needed as advances in biological sciences and medicine allow investigations to be made at the molecular level. For example, measurements of biomarkers that can drive clinical diagnosis often require ultra-sensitive detection of biomolecules. It is generally recognized that the most sensitive technology currently available for detection of molecules uses detection of fluorescence emission, and fluorescence-based single molecule detection (“SMD”) has become a viable approach to the sensitive detection of biomolecules. The challenge of fluorescent SMD is to maximize the signal to background ratio while continuing to lower the detection limits. In addition to detection and quantification of single molecules, information to identify or discriminate between different molecules in a mixture is critical to the successful application of SMD technology. Using current SMD methods a number of artifacts or fluorescence from impurities in the sample can lead to erroneous interpretations. Enhanced methods of analysis are extremely useful for working with very small amounts of samples and for detecting low concentrations of substances.

The first studies of fluorescence intensity fluctuations demonstrated the ability to measure fluctuations in the number of fluorescent molecules detected per unit time in a fixed volume. This established a technology called fluorescence correlation spectroscopy (“FCS”). FCS excels in providing information about dynamic processes over time in an ensemble of molecules, but can also be used for SMD. Basic instruments detect fluorescence emission from a small, open, static measurement volume. The measurement volume is defined by a focused laser beam, which excites the fluorescence, and by a pinhole in the image plane of the microscope collecting fluorescence. Fluorescence emissions are proportional to the number of fluorescent molecules present as they diffuse into and out of the measurement volume and as they are created or eliminated by the chemical reactions under observation. The detected fluorescence data are processed based on autocorrelation analysis. The disadvantage of autocorrelation is that random background is generally included in the analysis. In contrast, cross-correlation analysis, which requires data acquired from two detectors, allows signals from random background that are detected in only one detector but not both detectors to be eliminated.

Methods and apparatus for detecting and discriminating molecules have been described. In most cases, data analysis utilizes only one measurable characteristic of the target particles. While these analyses are sufficient for simple cases of detection and discrimination, they may not yield reliable results for samples composed of complex mixtures. Most targets possess multiple characteristics that can be measured and when those measurements are included in the data analysis, the power of the analysis will increase.

Instruments with dual detectors and flowing samples have been described, but while they enable use of cross-correlation analysis, the discrimination of target particles was based only on their velocity in the systems described. FCS generally distinguishes different particles according to their diffusion rate for static samples, or velocity for flowing samples. Fluorescence intensity distribution analysis (“FIDA”), uses the same type of data as FCS, but processes it in a different way to distinguish particles according to their specific brightness. Thus, both FCS and FIDA rely on measurement of only a single specific physical property.

Particle discrimination based only on fluorescence decay lifetime has been described. Methods and an apparatus that uses flowing samples are used to measure time-resolved fluorescence decay using a pulsed laser for particle illumination at a single location in the sample stream. While photon bursts are related to the laser pulse that created them, the discrimination of particles in this system is not related to the flow velocity of the particles.

In two-color fluorescence cross-correlation analysis discrimination is based on only emission wavelengths. These studies use a flowing sample and data collected by two detectors each measuring a different emission wavelength. Particles emitting one color, and detected by only one detector, are distinguished from particles emitting both colors and detected by both detectors. Similar techniques have been described using static samples and two detectors. Others have demonstrated that two detectors can be used to measure different emission wavelengths from a single interrogation volume. Sometimes referred to as coincidence analysis, these methods are rapid and accurate for target identification, but still utilize only one particle characteristic.

Methods that utilize more than one measurable characteristic for detecting and discriminating target molecules have also been described. Some have used methods for distinguishing between particles with similar spectroscopic properties based on one characteristic, burst size, but used another characteristic, intraburst fluorescence decay rate (fluorescence lifetime), to reduce background. A flowing sample with a single interrogation volume, detector, and pulsed laser use such methods. The resulting data is analyzed by correlating measurements of burst size and fluorescence lifetime to reduce background bursts and accidental coincidences. Fluorescence burst size and lifetime are similar spectroscopic properties that may both be subject to artifacts of the detection system which will limit the power of combining them for data analysis.

In another technology, fluorescence activated cell sorting (FACS) or flow cytometry, uses more than one parameter, such as fluorescence intensities at different wavelengths and light scattering in different directions, to distinguish target particles, but measurement of particle mobility cannot be utilized because particles move at uniform velocity.

Thus, what is needed are methods that utilize the measurement of multiple diverse properties of the target for increasing the reliability of the analysis of samples by accurately distinguishing between actual particles and general radiation background of the detection system.

### BRIEF SUMMARY OF THE INVENTION

Accordingly, it is an object of the invention to overcome these and other problems associated with the related art. These and other objects, features and technical advantages are achieved by combining technologies that use two interrogation volumes through which a sample flows, cross-correlation analysis of the two streams of data collected from those interrogation volumes, and analytical filters to select events with a high probability of being produced by the target particles.

This invention provides a method for enhancing the analysis of particle detection comprising measuring a first electromagnetic radiation signal provided by a particle within a first interrogation volume and optionally applying a first analytical filter to the first electromagnetic radiation signal and measuring a second electromagnetic radiation signal emitted by the particle in a second interrogation volume and optionally applying a second analytical filter to the second electromagnetic radiation signal, comparing by cross-correlation the electromagnetic radiation signal emitted by the particle within the first interrogation volume to the electromagnetic radiation signal emitted by the particle within the second interrogation volume, and further applying a third analytical filter to the cross-correlation events, thereby enhancing the analysis of the particle detection.

In accordance with a further aspect of the invention, one of or both the first analytical filter and the second analytical filter are applied. In one alternative, both the first analytical filter and the second analytical filter are applied, and the first analytical filter and the second analytical filter are the same analytical filter. Preferably, the first and second analytical filters are selected from the group consisting of signals that are greater than a predetermined threshold level, signals within a predetermined number of adjacent time segments, and a combination thereof. In accordance with another aspect of the invention, applying the third analytical filter comprises detecting a particle characteristic selected from the group consisting of emission intensity, burst size, burst duration, fluorescence lifetime, fluorescence polarization, and any combination thereof.

In accordance with yet another aspect of the invention, the particle characteristic is provided by one of an intrinsic parameter of the particle or an extrinsic parameter of the particle. Preferably, the extrinsic parameter is provided by marking the particle with at least one label selected from the group consisting of a dye tag, a light-scattering tag, and any combination thereof.

In accordance with yet another aspect of the invention, the first analytical filter, the second analytical filter and the third analytical filter are applied before cross-correlating the first electromagnetic radiation signal and second electromagnetic radiation signal.

In accordance with a further aspect of the invention, the first and second interrogation volumes are in electromagnetic communication with at least one excitation source selected from the group consisting of a light-emitting diode, a continuous wave laser, and a pulsed laser.

In accordance with yet another aspect of the invention, the particle is selected from the group consisting of a polypeptide, a polynucleotide, a nanosphere, a microsphere, a dendrimer, a chromosome, a carbohydrate, a virus, a bacterium, a cell, and any combination thereof. In one alternative, the particle is selected from the group consisting of an amino acid, a nucleotide, a lipid, a sugar, a toxin, and any combination thereof. In another alternative, the particle is selected from the group consisting of an aggregate, a complex, an organelle, a micelle, and any combination thereof.

In accordance with a further aspect of the invention, the method comprises moving a target particle through the first interrogation volume and through the second interrogation volume by a force selected from the group consisting of electro-kinetic force, pressure difference, osmotic difference, ionic difference, gravity, surface tension, centrifugal force, a magnetic field, an optical field, and any combination thereof.

In accordance with a further aspect of the invention, the target particle is one of a population of different particles. In one alternative, the target particle is moved through the first interrogation volume and through the second interrogation volume with the population of different particles at a uniform velocity by a force selected from the group consisting of positive pressure, negative pressure, gravity, surface tension, inertial force, centrifugal force, and any combination thereof. In another alternative, the target particle is moved through the first interrogation volume and through the second interrogation volume with the population of different particles at a different velocity by a force selected from the group consisting of electro-kinetic force, centrifugal force, a magnetic force, an optical force, and any combination thereof. Preferably, the target particle mobility is determined by an intrinsic parameter of the particle or an extrinsic parameter of the particle. Still more preferably, the extrinsic parameter of the target particle is provided by a label selected from the group consisting of a charge tag, a mass tag, a charge/mass tag, a magnetic tag, an optical tag, and any combination thereof.

In accordance with yet another aspect of the invention, the electromagnetic radiation signal is selected from the group consisting of stimulated emission, fluorescence, elastic light scattering, inelastic light scattering, and any combination thereof.

In accordance with yet another aspect of the invention, the electromagnetic radiation signal passes through an optical band pass filter within an image plane of a detector. Preferably, the optical band pass filter enables differential detection of emission spectra.

In accordance with yet another aspect of the invention, the analysis comprises multiple passes through the processes of applying analytical filters and comparing the electromagnetic radiation signal emitted by the particle within the first interrogation volume to the electromagnetic radiation signal emitted by the particle within the second interrogation volume.

These and other features, aspects and advantages of the present invention will become better understood with reference to the following description, examples and appended claims.

### BRIEF DESCRIPTION OF THE SEVERAL VIEWS OF THE DRAWINGS

FIG. 1. Schematic diagram of the basic apparatus for single molecule detection using laser induced fluorescence.

FIG. 2. Schematic diagram of the interrogation chamber for the single molecule analyzer.

FIG. 3. Panel shows linearized pUC19 at 7.5 fM in PBS with 0.01% casein hydrolysate pumped through the analyzer at 1 ml/min. Initial cross-correlation of the data revealed no discernable peaks.

FIG. 4. Panel shows linearized pUC19 at 7.5 fM in PBS with 0.01% casein hydrolysate pumped through the analyzer at 1 ml/min. Restricting the cross-correlations to only those events with a brightness of 15-500 allowed for detection of a dominant peak at around 80 ms. Panels C and D shows the plot of elapsed time vs. time of sample run with a 7.2 kb DNA fragment labeled with Alexa Fluor®647 subjected to electrophoresis at 3000V for 60 seconds in 0.2× TB, 0.01% SDS.

FIG. 5. Panel shows linearized pUC19 at 7.5 fM in PBS with 0.01% casein hydrolysate pumped through the analyzer at 1 ml/min. The shoulder on the peak is composed of events that occurred primarily in the last half of the sample run (dot density is higher near the top of the chart), suggesting a change in the electrophoresis system with time.

FIG. 6. Panel shows linearized pUC19 at 7.5 fM in PBS with 0.01% casein hydrolysate pumped through the analyzer at 1 ml/min. Restricting the data set based on time shows the same data excluding the last 30 seconds of the run. The resulting histogram shows a single peak primarily without the shoulder that was an artifact of changes in the electrophoresis system.

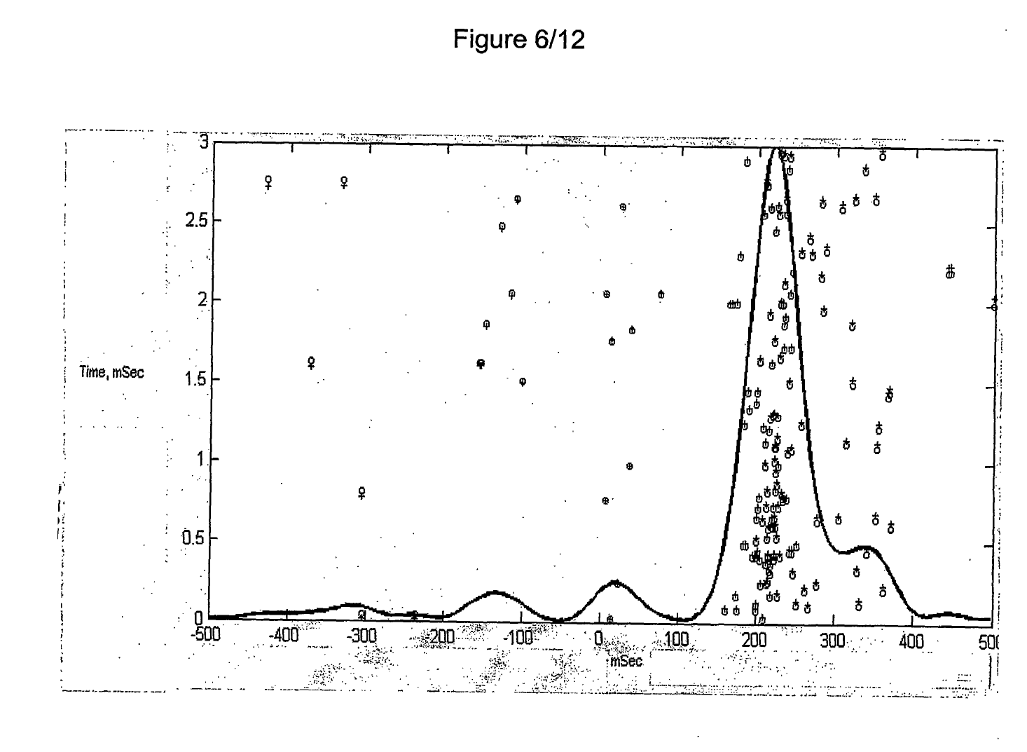

FIG. 7. Fluorescence brightness is plotted against the elapsed time between detectors. Each spot represents measurements taken on a single molecule. The scale of the x-axis (elapse time) was restricted to emphasize the events that occur within the peak. A separation value of 500 photons was used to divide the bright window from the dim window. PBXL-3 molecules (this figure) emit at a higher average intensity than the pUC19 molecules (FIG. 8).

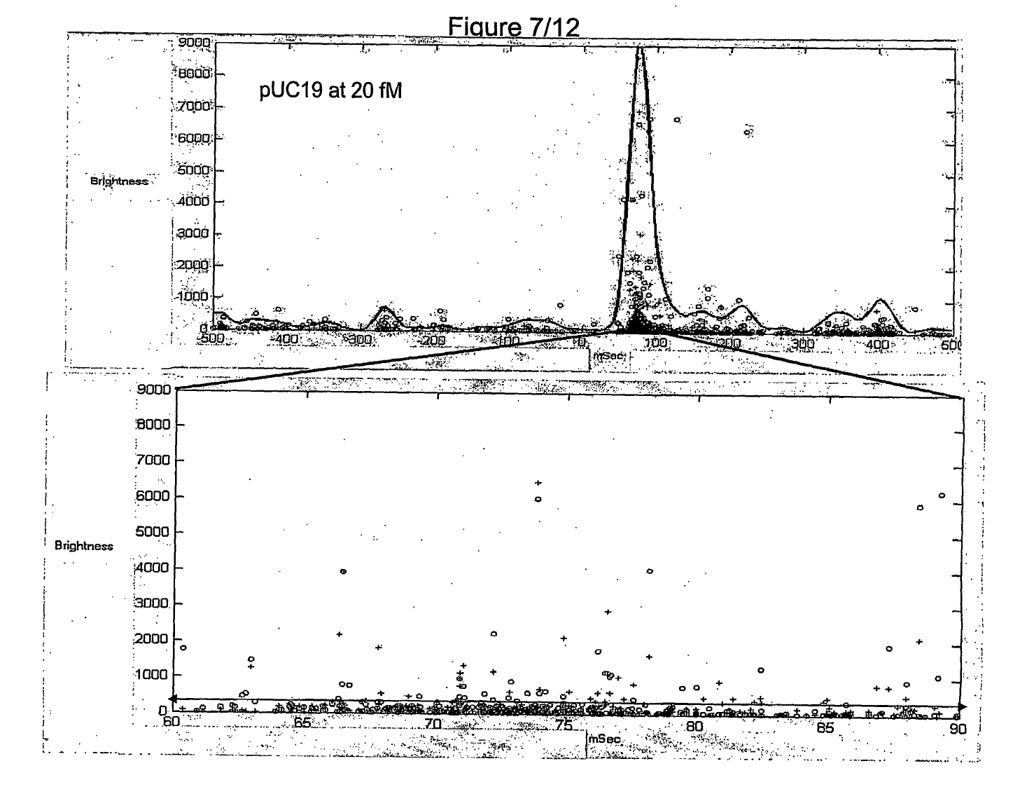

FIG. 8. Fluorescence brightness is plotted against the elapsed time between detectors. Each spot represents measurements taken on a single molecule. The scale of the x-axis (elapse time) was restricted to emphasize the events that occur within the peak. A separation value of 500 photons was used to divide the bright window from the dim window. PBXL-3 molecules (FIG. 7) emit at a higher average intensity than the pUC19 molecules (This figure).

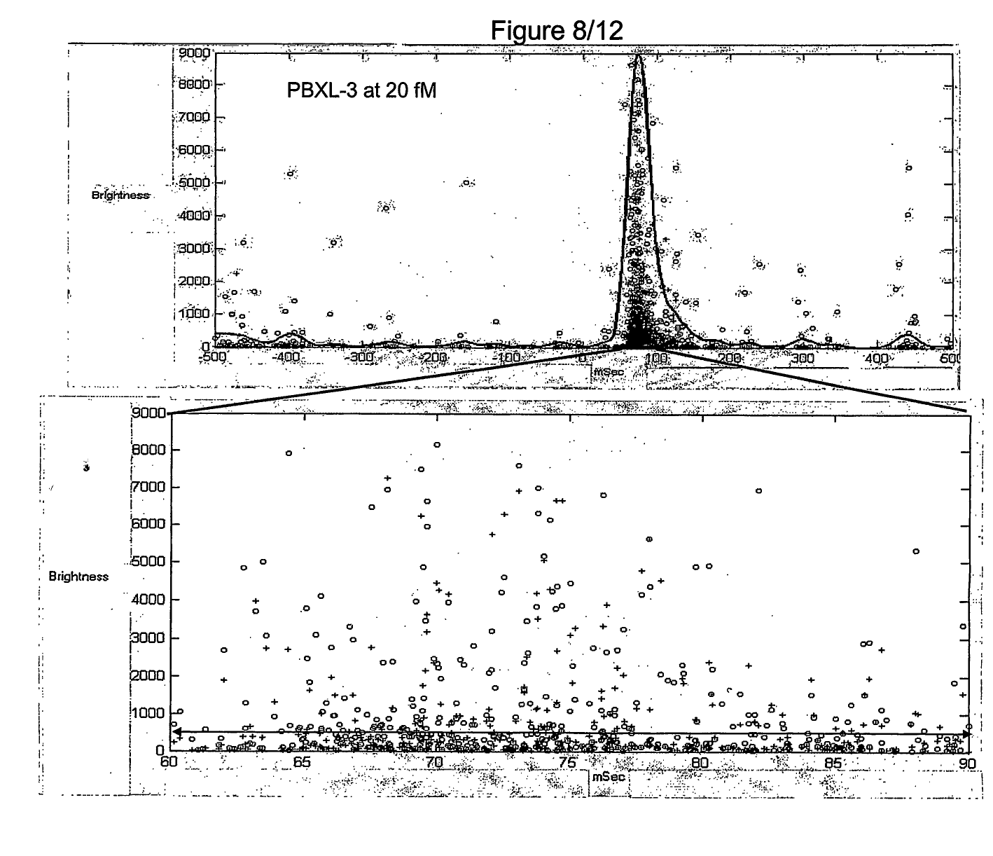

FIG. 9. The measured values of the concentration of PBXL-3 and pUC19 components in mixtures are compared to the predicted values.

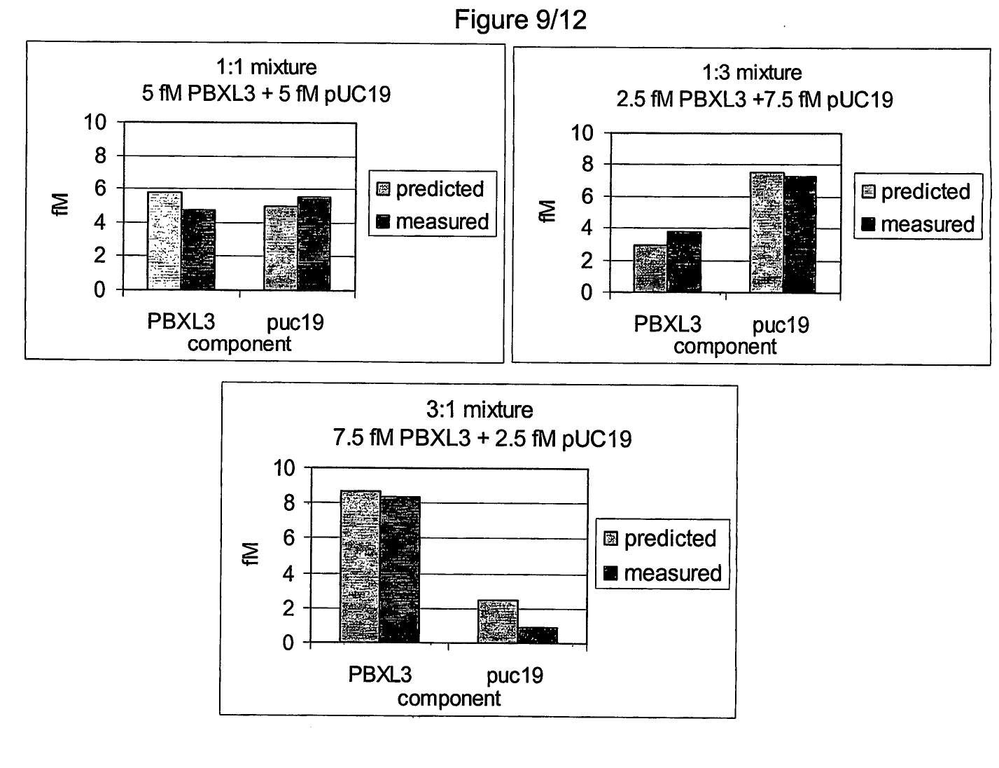

FIG. 10, FIG. 5. A sample that contains a protein and nucleic acid, both labeled with Alexa Fluor®647. The broadest peak width analytical filter (0-5 bins) was optimal for detecting the two peaks, demonstrating discrimination based on both the electrophoretic velocity and the peak width.

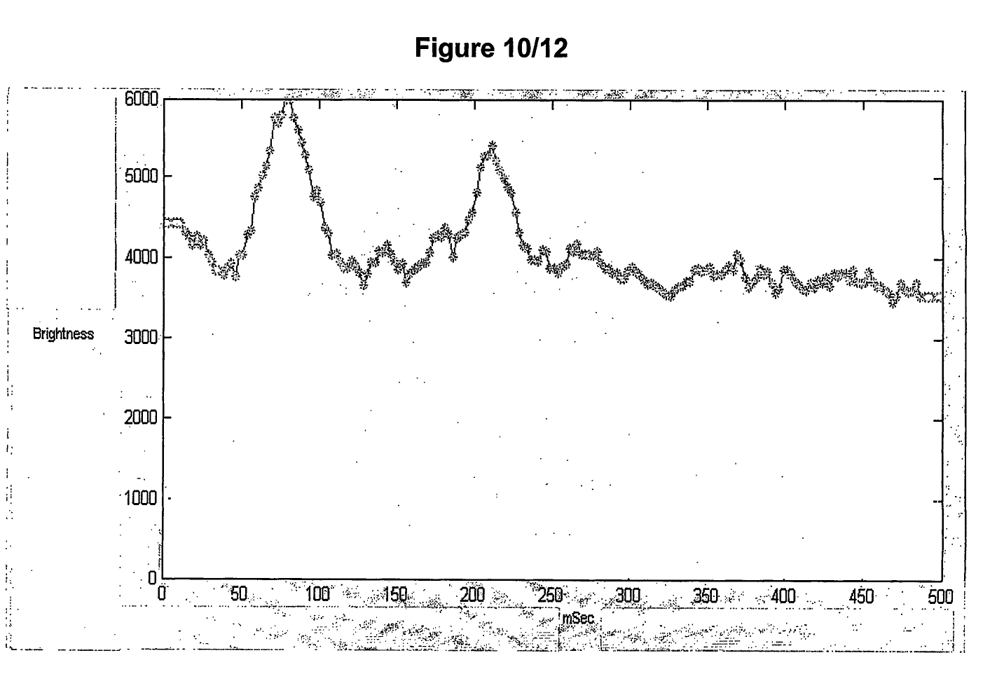

FIG. 11. A sample that contains a protein and nucleic acid, both labeled with Alexa Fluor®647. When the analysis was performed with narrower peak width analytical filters, only one peak is seen, a faster moving peak corresponding to the protein (0-1 bins) and

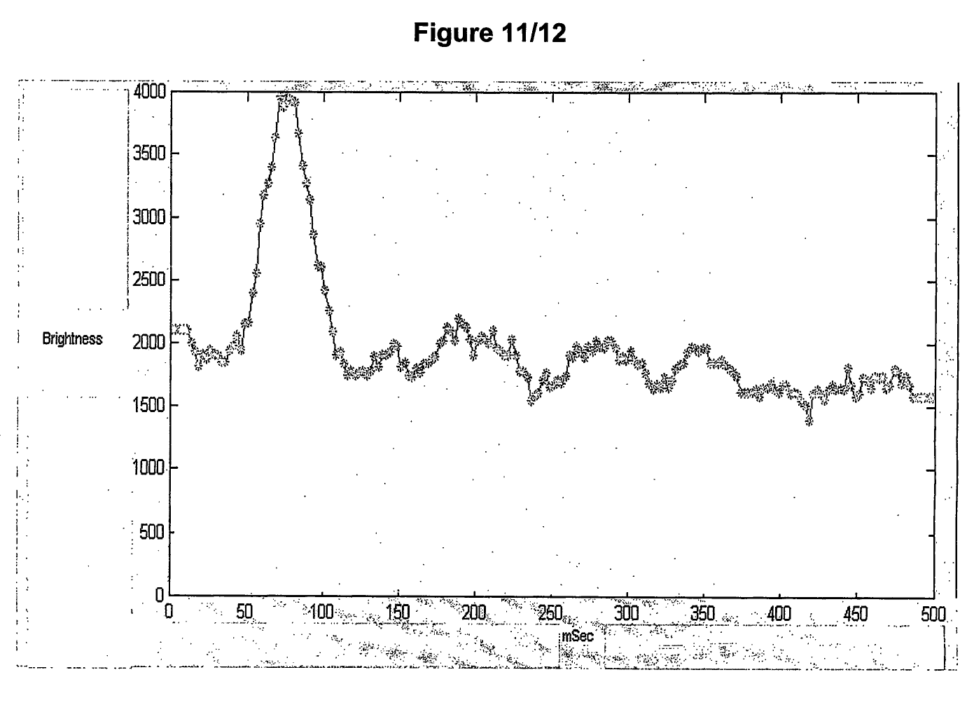

FIG. 12. A sample that contains a protein and nucleic acid, both labeled with Alexa Fluor®647. When the analysis was performed with narrower peak width analytical filters, a slower moving peak corresponding to the nucleic acid (1-5 bins).

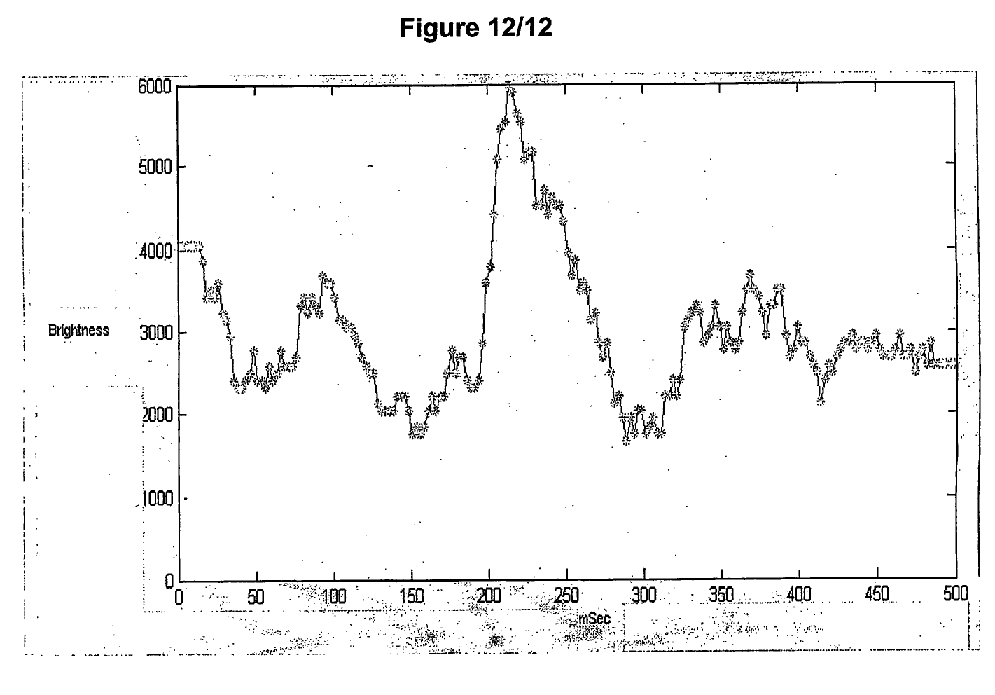

### DETAILED DESCRIPTION OF THE INVENTION

### Abbreviations and Definitions

To facilitate understanding of the invention, a number of terms and abbreviations as used herein are defined below as follows:

Analytical filter: As used herein, the term “analytical filter” refers to methods where the measured electromagnetic signals or events that are identified by cross-correlation are compared to criteria that are known to match the characteristics of the target particle. When the filter is applied, only those signals or events that meet the criteria of the filter are selected, counted, and used in the analysis results.

Background: As used herein, the term “background” refers to signals that are detected, but do not originate from a target particle in the sample. Sources of background signals include Raman and Rayleigh scattering from solutes, scattering from the capillary walls, and fluorescent contaminants within the sample.

Band pass filter: As used herein, the term “band pass filter” refers to an optical filter that allows transmission of a specific range of frequencies and rejects frequencies both above and below that range.

Binding partner(s): As used herein, the term “binding partners” refers to macromolecules that combine through molecular recognition to form a complex. Molecular recognition involves topological compatibility or the matching together of interacting surfaces on each partner. The partners can be described as complementary, and furthermore, the contact surface characteristics are complementary to each other. Binding forces can be hydrophobic, hydrophilic, ionic, hydrogen, covalent, hybridization, induced fit, polarizing, induced polarization, and intercalation. Examples of binding partners are antigen/antibody, oligonucleotide/nucleic acid, inhibitor/enzyme, and ligand/receptor.

Bins: As used herein, the term “bins” refers to uniform arbitrarily chosen time segments that are used to divide the electromagnetic radiation signals that are recorded in each detector channel. Bin widths are typically in the range of 1 μs to 5 ms.

Brightness: As used herein, the term “brightness” refers to total number of photons detected within a peak of emission that consists of adjacent time segments (bins) where the number of photons is above the average background number of photons. A synonymous term is fluorescence burst size.

Charge tags: As used herein, the term “charge tag” refers to any entity bearing a charge that when bound to or associated with the target distinguishes the charge tag+target from the target alone based on detection of the mass, charge, or charge to mass ratio. A charge tag can be a label.

Charge/mass tags: As used herein, the term “charge/mass tag” refers to any charge and mass added to the target that serves to distinguish the charge/mass tag+target from the target alone based on detection of the mass, charge, or charge to mass ratio. A charge/mass tag can be a label.

Cross-correlation: As used herein, the term “cross-correlation” involves subjecting two data sets gⱼ and hₖ to analysis, whereby data sets from each detector (preferably photon detectors) are subjected to the following formula:

$${Corr ( g , h )}_{j} ≡ {\sum }_{k = 0}^{N - 1} {g}_{j + k} {h}_{k} , \\ for$$

$$j = - ( N - 1 ) , - ( N - 2 ) , … , - 1 , 0 , 1 , … , N - 1$$

where N is the total number of data points. The data cross-correlations will be large at values of j where the first data set from a detector (preferably photon counts above a background level) (g) resembles the data set (h) from a second detector (preferably above a background level) at some lag time (j) that corresponds to the time for specific particles to pass from the first detector to the second detector (preferably in a single molecule analytical system). In a single molecule electrophoresis instrument with an electric field applied to the sample, the lag time (j) for detection between photon detectors arrayed along the length of capillary is related to the electrophoretic velocity of a detected particle.

Dye: As used herein, the term “dye” refers to a substance used to color materials or to enable generation of luminescent or fluorescent light. A dye may absorb light or emit light at specific wavelengths. A dye may be intercalating, noncovalently bound or covalently bound to a target. Dyes themselves may constitute labels that detect minor groove structures, cruciforms, loops or other conformational elements of molecules. Dyes may include BODIPY and ALEXA dyes, Cy[n] dyes, SYBR dyes, ethidium bromide and related dyes, acridine orange, dimeric cyanine dyes such as TOTO, YOYO, BOBO, TOPRO POPRO, and POPO and their derivatives, bis-benzimide, OliGreen, PicoGreen and related dyes, cyanine dyes, fluorescein, LDS 751, DAPI, AMCA, Cascade Blue, CL-NERF, Dansyl, Dialkylaminocoumarin, 4′,5′-Dichloro-2′,7′-dimethoxyfluorescein, 2′,7′-Dichlorofluorescein, DM-NERF, Eosin, Erythrosin, Fluoroscein, Hydroxycourmarin, Isosulfan blue, Lissamine rhodamine B, Malachite green, Methoxycoumarin, Naphthofluorescein, NBD, Oregon Green, PyMPO, Pyrene, Rhodamine, Rhodol Green, 2′,4′,5′,7′-Tetrabromosulfonefluorescein, Tetramethylrhodamine, Texas Red, X-rhodamine. Additional fluorophore families include Dyomics series, Atto tec series, coumarins, macromolecular, phycobilliproteins (including phycoerythrins, phycocyanins, and allophycocyanins), green, yellow, red, and other fluorescent proteins, up-converting phosphors, and Quantum Dots. Those skilled in the art will recognize other dyes which may be used within the scope of the invention. This list includes but is not limited to all dyes now known or known in the future which could be used to allow detection of the labeled polypeptide or polynucleotide of the invention.

Elapsed time: As used herein, the term “elapsed time” refers to the number of seconds, or partial seconds, e.g., milliseconds (ms), required for particles to travel the distance between two interrogation volumes. Synonymous terms are transit time, time-offset, and inverse velocity.

Electrophoretic Velocity: As used herein, the term “electrophoretic velocity” refers to the velocity of a charged target under the influence of an electric field relative to the background electrolyte. Net velocity in a capillary system may be a composite measure of electrokinetic velocity and electroosmotic velocity.

Emission: As used herein, the term “emission” refers to radiation generated by a molecule or particle in processes such as fluorescence and elastic or inelastic (e.g., Raman) light scattering.

Emission wavelength: As used herein, the term “emission wavelength” refers to the spectrum of the photons that are released during emission and measured by the detectors used in the analysis instrument. For polyatomic particles in solution, fluorescent photon emissions occur over a spectrum typically in the range of 100-150 nm. A selected subset of the spectrum is allowed to pass to the detectors by the optical band pass filters used in the instruments. Labels that are detected in the same spectral range are considered to have the same emission wavelength.

Event: As used herein, the term “event” refers to a cross-correlated signal. Events may or may not be the result of fluorescence from a target particle. Events are considered to be of interest if they meet additional criteria known to match the characteristics of the target particle.

Fluid: As used herein, the term “fluid” is a medium wherein particles are suspended and move. It can be gaseous, aqueous, non-aqueous, or any combination thereof. In some cases, it can have an electric field or conduct an electrical current. It may further contain salts, ions, polymers, macromolecules, or other agents that can interact with the polypeptides or polynucleotides and influence their movement.

Fluorescence: As used herein, the term “fluorescence” refers to the photons of energy that are emitted as an excited fluorophore returns to its ground state. The energy of the emitted photon is usually, but not always lower, and therefore of longer wavelength, than the excitaton photon.

Fluorescence Burst Duration: As used herein, the term “fluorescence burst duration” refers to the period of time during which an emission event is detected. A synonymous term is peak width.

Fluorescence Intensity: As used herein, the term “fluorescence intensity” refers to the total number of photons measured during a single time segment (e.g., over a millisecond and above a background level).

Fluorescence Lifetime: As used herein, the term “fluorescence lifetime” refers to the time required by a population of N excited fluorophores to decrease exponentially to N/e by losing excitation energy through fluorescence and other deactivation pathways.

Fluorescence Polarization: As used herein, the term “fluorescence polarization” refers to the property of fluorescent particles in solution that are excited with plane-polarized light and emit light back into a fixed plane (i.e., the light remains polarized) if the particles remain stationary during the excitation and emission cycle of the fluorophore.

Interrogation volume: As used herein, the term “interrogation volume” is the space, through which at least one particle may traverse, that is illuminated by the illumination source and observed, sensed or otherwise detected by the detectors.

Label: As used herein, the term “label” refers to an entity that, when attached to the target particle of the invention, alters measurable parameters of the particle such as its electromagnetic emission or its electrophoretic velocity. Exemplary labels include but are not limited to fluorophores, chromophores, radioisotopes, spin labels, enzyme labels, mass tags, charge tags, and charge/mass tags. Such labels allow detection of labeled compounds by a suitable detector. In addition, such labels include components of multi-component labeling schemes, e.g., a system in which a target binds specifically and with high affinity to a detectable binding partner, e.g., a labeled antibody binds to its corresponding antigen. Herein, label and “tag” are used synonymously.

Light Scattering: As used herein, the term “light scattering” refers to processes by which photons change directions. It includes both elastic light scattering where photons change direction without changing their wavelength and inelastic scattering where the scattered radiation has a different (normally lower) energy from the incident radiation.

Mass tags: As used herein, the term “mass tag” refers to any mass added to the target that serves to distinguish the mass tag+target from the target alone based on detection of the mass, or charge to mass ratio. A mass tag can be a label.

Particle: As used herein, the term “particle” means an entity that can be detected, counted and/or discriminated in the current invention. Examples of particles are proteins, nucleic acids, nanospheres, microspheres, aggregates, dendrimers, organelles, chromosomes, carbohydrates, micelles, viruses, bacteria, cells, prions, and chemical entities (such as amino acids, nucleotides, lipids, sugars, toxins, venoms, drugs, reaction products arid substrates).

Sample: As used herein, the term “sample” shall mean a contiguous volume containing at least one detectable particle. This term shall include, but shall not be limited to, detecting the particle in one sample run. The term “sample” also refers to the volume that contains only the detectable labels in the case when they are released from the original target particles, and are analyzed in the released state.

Signal: As used herein, the term “signal” refers to the output of a detection system that measures the electromagnetic radiation from a fluorescing particle.

SMD: As used herein, the term “SMD” refers to single molecule detection.

Target: As used herein, the term “target” refers to the particle to be detected in an assay. This term is also known in the art as an analyte.

### Methods for Enhancing the Analysis of Particle Detection

The invention provides methods for increasing the reliability of the analysis of samples by accurately distinguishing between actual particles and radiation background. This is accomplished by combining technologies that use two interrogation volumes through which a sample flows, cross-correlation analysis of the two streams of data collected from those interrogation volumes, and analytical filters to select events with a high probability of being produced by the target particles.

The methods of the invention strive to increase the reliability of SMD data analysis by distinguishing between target particles, contaminants, and general noise of the detection system. In addition, the invention allows for increased accuracy of discrimination between particles in a mixture by a novel series of steps taken for data analysis. These analyses result in determining a particle's mobility through cross-correlation of particle emissions measured independently in two interrogation volumes, and identifying true cross-correlation events by applying analytical filters based on electromagnetic emission characteristics together with the cross-correlation analysis.

The present invention is an important step in the advancement of SMD. Biological sciences and medicine are driving development of methods for detection of particles to lower and lower levels. The ultimate detection level desired is that of individual particles, interactions between individual particles, and individual complexes of particles. Applications for ultrasensitive detection include monitoring for bioterror agents, medical application such as in the detection of drugs of abuse, biomarkers for therapeutic dosage monitoring, health status, donor matching for transplantation purposes, pregnancy, and detection of disease, pathogens, and the like, and applications in environmental, ecological, and industrial monitoring, manufacturing process monitoring and food safety.

Achieving the goal of single particle detection is within the scope of laser-induced detection systems; however, the lower the detection level, the more challenging it is to maximize the signal to background ratio. Depending on the source of the background, various methods have been implemented to reduce background radiation such as using very small interrogation volumes, specific band pass filters, pulsed lasers with time-gated detection, and near-infra red emission and detection. Methods of data analysis can also be used to discriminate true signals from background. The current invention uses a data analysis process to enhance the sensitivity and accuracy of single particle detection. The process combines cross-correlation analysis with methods for filtering based on electromagnetic radiation characteristics to increase the discrimination power of the analysis.

The samples used in the invention contain target particles. Such particles include molecules and organisms. Examples of molecular particles include biopolymers such as proteins, nucleic acids, carbohydrates, and small molecule chemical entities. Chemical entities encompass small molecules such as amino acids, nucleotides, lipids, sugars, drugs, toxins, venoms, substrates, reaction products, pharmacophores, and any combination thereof. Other examples of particles include nanospheres, microspheres, dendrimers, chromosomes, organelles, micelles and carrier particles. Examples of organelles include subcelluar particles such as nuclei, mitochondria, and endosomes. Examples of organisms include viruses, bacteria, fungal cells, animal cells, plant cells, eukaryotic cells, prokaryotic cells, archeobacteria, prions, and any combination thereof. Also included are particles composed of complexes of molecules, organisms with labels bound, complexes of two or more nucleic acids, and complexes of target particles bound to one or more antibodies or antibody fragments. Also included are complexes where two or more types of single particles are detected, such as any particles selected from the list of protein, receptor, DNA, RNA, pNA, LNA, carbohydrate, organelle, virus, cell, bacterium, fungus, or fragments thereof, combined with any or all in the list and/or any or all combinations thereof.

In one embodiment, chemical entities includes naturally occurring hormones, naturally occurring drugs, synthetic drugs, pollutants, allergens, effecter molecules, growth factors, chemokines, cytokines, lymphokines, amino acids, oligopeptides, chemical intermediates, nucleotides, and oligonucleotides.

In another embodiment, particles include labels that were bound to target particles, separated from unbound labels, and interacted with an agent causing the release of the bound labels. These released labels can be considered as particles, and analyzed by the methods of the current invention, thereby indirectly detecting the original target particle.

Of particular interest is detection of microorganisms and cells, including viruses, prokaryotic and eukaryotic cells, unicellular and multicellular organism cells, e.g., fungi, animal, mammal, or fragments thereof. The methods of the invention may also be used for detecting pathogens. Pathogens of interest may be, but are not limited to, viruses such as Herpesviruses, Poxviruses, Togaviruses, Flaviviruses, Picomaviruses, Orthomyxoviruses, Paramyxoviruses, Rhabdoviruses, Corona viruses, Arenaviruses, and Retroviruses. They may also include bacteria including but not limited to Escherichia coli, Pseudomonas aeruginosa, Enterobacter cloacae, Staphylococcus aureus, Enterococcus faecalis, Klebsiella pneumoniae, Salmonella typhimurium, Staphylococcus epidermidis, Serratia marcescens, Mycobacterium bovis, methicillin resistant Staphylococcus aureus and Proteus vulgaris.

The examples of such pathogens are not limited to those listed above, and one skilled in the art will know which specific species of microorganisms and parasites are of particular importance. The non-exhaustive list of these organisms and associated diseases can be found for example in U.S. Pat. No. 5,795,158 issued to Warinner and incorporated herein by reference in its entirety.

Particles of the invention can be obtained from biological specimens, including separated or unfiltered biological liquids such as urine, cerebrospinal fluid, pleural fluid, synovial fluid, peritoneal fluid, amniotic fluid, gastric fluid, blood, serum, plasma, lymph fluid, interstitial fluid, tissue homogenate, cell extracts, saliva, sputum, stool, physiological secretions, tears, mucus, sweat, milk, semen, seminal fluid, vaginal secretions, fluid from ulcers and other surface eruptions, blisters, and abscesses, and extracts of tissues including biopsies of normal, malignant, and suspect tissues or any other constituents of the body which may contain the target particle of interest. Other similar specimens such as cell or tissue culture or culture broth are also of interest. The test sample can be pre-treated prior to use, such as preparing plasma from blood, diluting viscous fluids, or the like; methods of treatment can involve filtration, distillation, concentration, inactivation of interfering compounds, and the addition of reagents.

### Multiple Particle Assays

In one embodiment, several types of particles may be detected and discriminated in the same sample. Examples of combinations of particles that are of special interest for the applications of the invention include an infectious agent/antibody to the agent, an infectious agent/nucleic acid/toxin, cancer cell/dysregulated protein, mRNA/corresponding protein transcript, gene(DNA)/message(RNA), gene(DNA)/protein, virus/toxin, bacterium/toxin, enzyme/substrate, and enzyme/product.

Reactive particles may be analyzed through their interaction with specific ligands, cofactors, agonists or antagonists. Furthermore, enzymes in solution may be detected by monitoring changes (electrophoretic velocity, brightness, or other properties) of the substrate of the enzyme or of a substance that interacts with the substrate. In another embodiment, multiple particles of the same type are discriminated in the same sample. For example, mixtures of nucleic acid fragments of varying length or sequence, or mixtures of proteins with different sizes or charge to mass ratio can be discriminated.

Particles must provide, directly or indirectly, electromagnetic radiation to be detected. The electromagnetic radiation may be an intrinsic property of the particle, an extrinsic property of the particle, or a combination thereof. Examples of intrinsic properties can include fluorescence, and light scattering. A particle may possess more than one intrinsic property that renders it detectable. Extrinsic properties are those that are provided by a label when it is attached to the particle. Labels are applied before, after, or simultaneously with positioning the particle into the interrogation fluid. Once a particle is detectably labeled, any suitable means of detection that are known in the art can be used. Different characteristics of the electromagnetic radiation may be detected including: emission wavelength, emission intensity, burst size, burst duration and fluorescence polarization. The only proviso is that the means of detection can be used in accordance with an SMD instrument such as that provided in U.S. Pat. No. 4,793,705, incorporated herein by reference in its entirety. A particle may be detectable based on any combination of intrinsic and extrinsic properties. Preferably, the means of detection is a fluorescent label.

In one aspect of the invention, photons are counted from samples emitting fluorescent light. However, it may be desirable in some embodiments to monitor photon counts of origin other than fluorescence, such as light scattering or Raman radiation.

In a preferred embodiment, the emitted radiation is monitored in terms of the numbers of photons counted in consecutive time intervals. In another preferred embodiment emissions are monitored in terms of time of arrival of photons at the two detectors. In a further preferred embodiment, emissions are monitored in terms of time intervals between consecutive photon bursts.

The labeling of the particle with a means of detection is within the ordinary skill in the art. Attaching labels to particles can employ any known means including attaching directly or by means of binding partners. In some cases, the method of labeling is non-specific, for example, a method that labels all nucleic acids regardless of their specific nucleotide sequence. In other cases, the labeling is specific, as in where a labeled oligonucleotide binds specifically to a target nucleic acid sequence. Specific and non-specific labeling techniques will be discussed in more detail in the following sections.

Labels include dye tags, charge tags, mass tags, quantum dots, or beads, magnetic tags, light scattering tags, polymeric dyes, dyes attached to polymers. Dyes include a very large category of compounds that add color to materials or enable generation of luminescent or fluorescent light. A dye may absorb light or emit light at one or more wavelengths. A dye may be intercalating, or be noncovalently or covalently bound to a particle. Dyes themselves may constitute probes such as dye probes that detect minor groove structures, cruciforms, loops or other conformational elements of particles. In one embodiment, the label may be non-fluorescent in the unbound state, but become fluorescent through changes that occur in the molecule when it binds to the target particle.

By having fluorescent markers, such as fluorescent particles, fluorescent conjugated antibodies, or the like, the sample may be irradiated with light that is absorbed by the fluorescent particles and the emitted light measured by light measuring devices.

Useful light scattering tags include metals such as gold, selenium and titanium oxide, as well as nanoclusters of materials, such as ceramics or metals. Certain microspheres or beads can also be used as light scattering tags.

In yet another aspect, the labels affect the electrophoretic velocity and/or separation of target particles of identical or different sizes. These labels are referred to as charge/mass tags. Attachment of a label can alter the ratio of charge to translational drag of the target particles in a manner and to a degree sufficient to affect their electrophoretic mobility and separation in sieving or non-sieving media. In another embodiment, the label alters the charge, or the mass, or a combination of charge and mass. The charge/mass tag bound to a particle can be discriminated from the unbound particle or unbound tag by virtue of spatial differences in their behavior in an electric field or by virtue of velocity differences in their behavior in an electric field.

Polysaccharide coated paramagnetic microspheres or nanospheres are used to label particles. U.S. Pat. No. 4,452,773, incorporated herein by reference in its entirety, describes the preparation of magnetic iron-dextran beads and provides a summary describing the various means of preparing particles suitable for attachment to biological materials. A description of polymeric coatings for magnetic particles used in high gradient magnetic separation (HGMS) methods is found in DE 3720844 and U.S. Pat. No. 5,385,707, both incorporated herein by reference in their entirety. Methods to prepare paramagnetic beads are described in U.S. Pat. No. 4,770,183, incorporated herein by reference in its entirety. The exact method for attaching the bead to the particle is not critical to the practice of the invention, and a number of alternatives are known in the art. The attachment is generally through interaction of the particle with a specific binding partner that is conjugated to the coating on the bead and provides a functional group for the interaction. Antibodies are examples of binding partners. Antibodies may be coupled to one member of a high affinity binding system, e.g., biotin, and the particles attached to the other member, e.g., avidin. One may also use secondary antibodies that recognize species-specific epitopes of the primary antibodies, e.g., anti-mouse Ig, anti-rat Ig. Indirect coupling methods allow the use of a single magnetically coupled entity, e.g., antibody and avidin, with a variety of particles.

In one application of this technique, the target particle is coupled to a magnetic tag and suspended in a fluid within a chamber. In the presence of a magnetic field supplied across the chamber, the magnetically labeled target is retained in the chamber. Materials which do not have magnetic labels pass through the chamber. The retained materials can then be eluted by changing the strength of, or by eliminating, the magnetic field. The chamber across which the magnetic field is applied is often provided with a matrix of a material of suitable magnetic susceptibility to induce a high magnetic field locally in the chamber in volumes close to the surface of the matrix. This permits the retention of weakly magnetized particles and the approach is referred to as high gradient magnetic separation.

Optical tags are well known to one skilled in the art and include any entity that augments the optical properties of a target particle when bound to that particle. Examples are beads, quantum dots, or other molecules that might affect properties such as reflectivity or absorbance.

In a further embodiment of the invention, the extrinsic properties that render the particle detectable are provided by at least two labels of characterized photon yield. For example, the target particle is labeled with two or more labels and each label is distinct due to detected emission at one or more wavelengths that is distinguishable from the emission of the other label(s). In this example, the particle is distinguished from free label by the ratio of detected emission at two or more wavelengths. In another example, the particle is labeled with two or more labels and at least two of the labels emit at the same wavelength. In this example particles are distinguished based on the difference in the intensity of the detected fluorescence produced by emission from the two, three, or more labels attached to each particle.

In another embodiment, the dyes have the same or overlapping excitation spectra, but possess distinguishable emission spectra. Preferably dyes are chosen such that they possess substantially different emission spectra, preferably having emission maxima separated by greater than 10 nm, more preferably having emission maxima separated by greater than 25 nm, even more preferably separated by greater than 50 nm. When it is desirable to differentiate between the two dyes using instrumental methods, a variety of optical filters and diffraction gratings allow the respective emission spectra to be independently detected. Instrumental discrimination can also be enhanced by selecting dyes with narrow bandwidths rather than broad bandwidths; however, such dyes should possess a high amplitude emission or be present in sufficient concentration that the loss of integrated signal strength is not detrimental to signal detection.

In one embodiment, the second label may quench the fluorescence of the first label, resulting in a loss of fluorescent signal for doubly labeled particles. Examples of suitable fluorescencing/quenching pairs include 5′ 6-FAMTM/3′ Dabcyl, 5′ Oregon Green® 488-X NHS Ester/3′ Dabcyl, 5′ Texas Red®-X NHS Ester/3′ BlackHole QuencherTM-1 (Integrated DNA Technologies, Coralville, Iowa).

In one embodiment, two labels may be used for fluorescence resonance energy transfer (FRET), which is a distance-dependent interaction between the excited states of two dye molecules. In this case, excitation is transferred from the donor to the acceptor molecule without emission of a photon from the donor. The donor and acceptor molecules must be in close proximity (1-10 nm). Suitable donor, acceptor pairs include fluorescein/tetramethylrhodamine, IAEDANS/fluorescein, EDANS/dabcyl, fluorescein/QSY7, (Haugland, 2002) and many others known to one skilled in the art.

Particles may be labeled with more than one kind of label, such as a dye tag and a mass tag, to facilitate detection and/or discrimination. For example, a protein may be labeled with two antibodies, one that is unlabeled and acts as a mass or mass/charge tag, and another that has a dye tag. That protein might then be distinguished from another protein of similar size that is bound only to an antibody with a dye tag by its difference in velocity (caused by the increased mass or altered mass/charge of the additional bound antibody).

### Distinguishing Labels

To accurately detect a labeled particle, the labeled particle must be distinguished from unbound label. Many ways to accomplish this are familiar to one skilled in the art. For example, in heterogeneous assays, unbound label is separated from labeled particles prior to analysis. In a preferred embodiment, the assay is a homogenous assay, and the sample, including unbound label, is analyzed by a combination of electrophoresis and single particle fluorescence detection. In this case, electrophoretic conditions are chosen which provide distinct velocities for the labeled particle and the unbound label.

Non-specific labeling of nucleic acids generally labels all nucleic acids regardless of the particular nucleotide sequence. One skilled in the art is familiar with various techniques for general labeling of nucleic acids. Methods include: intercalating dyes such as TOTO, ethidium bromide, and propidium iodide, ULYSIS kits for formation of coordination complexes, ARES kits for incorporation of a chemically reactive nucleotide analog to which a label can be readily attached, and incorporation of a biotin containing nucleotide analog for attachment of a streptavidin bound label. Enzymatic incorporation of labeled nucleotide analogs is another approach.

Techniques to non-specifically label proteins are also well known to one skilled in the art. Several chemically reactive amino acids on the surface of proteins have been used, for example, primary amines such a lysine. In additions, labels can be added to carbohydrate moieties on proteins. Isotype specific reagents have also been developed for labeling antibodies, such as Zenon labeling.

In a preferred embodiment, only specific particles within a mixture are labeled. Specific labeling can be accomplished by combining the target particle with a labeled binding partner, where the binding partner interacts specifically with the target particle through complementary binding surfaces. Binding forces between the partners can be covalent interactions or non-covalent interactions such as hydrophobic, hydrophilic, ionic and hydrogen bonding, van der Waals attraction, or coordination complex formation. Examples of binding partners are agonists and antagonists for cell membrane receptors, toxins and venoms, antibodies and viral epitopes, hormones (e.g., opioid peptides and steroids) and hormone receptors, enzymes and enzyme substrates, enzymes and enzyme inhibitors, binding cofactors and target sequences, drugs and drug targets, oligonucleotides and nucleic acids, proteins and monoclonal antibodies, antigen and specific antibody, polynucleotide and complementary polynucleotide, polynucleotide and polynucleotide binding protein; biotin and avidin or streptavidin, enzyme and enzyme cofactor; and lectin and specific carbohydrate. Illustrative receptors that can act as a binding partner include naturally occurring receptors, e.g., thyroxine binding globulin, lectins, various proteins found on the cell surfaces (e.g., cluster of differentiation or cluster designation, or CD molecules), and the like. An example is CD4, the molecule that primarily defines helper T lymphocytes. In a related embodiment, a binding partner may specifically bind to related particles. An example would be a peptide that binds to a family of related enzymes.

In one embodiment, a sample is reacted with beads or microspheres that are coated with a binding partner that reacts with the target particle. The beads are separated from any non-bound components of the sample, and the analyzer of the invention detects the beads containing bound particles. Fluorescently stained beads are particularly well suited for these methods. For example, fluorescent beads coated with oligomeric sequences will specifically bind to target complementary sequences, and after the appropriate separation steps, allow for detection of the target sequence.

In one embodiment, a method for detecting particles uses a sandwich assay with monoclonal antibodies as binding partners. An antibody is linked to a surface to serve as capture antibody. The sample is added and particles having the epitope recognized by the antibody would bind to the antibody on the surface. Unbound particles are washed away leaving substantially only those that are specifically bound. The bound particle/antibody can be reacted with a detection antibody that contains a detectable label. After incubating to allow reaction between the detection antibody and particles, unbound detection antibodies are washed away. The particle and detection antibody can be released from the surface and detected in the instrument of the invention. Alternatively, only the detection antibody might be released and detected, thereby indirectly detecting the particle.

A variation would be to employ a ligand recognized by a cell receptor. In this embodiment, the ligand is bound to the surface to capture the cells that express the specific receptor. For example, the receptor could be a surface immunoglobulin, and a labeled ligand used to label the cells. Therefore, having the ligand of interest complementary to the receptor bound to the surface, cells having the specific immunoglobulin for such ligand could be detected. In another embodiment, one could have antibodies to the ligand bound to the surface to non-covalently attach the ligand to the surface.

In another embodiment, binding partners include any entity that can produce a detectable particle such as an enzyme that converts a substrate to a fluorescent form, or a chemical that induces fluorescence in another molecule.

### Motive Forces

The sample to be detected may be subjected to electrophoresis. Mobility of particles within the sample fluid varies with the properties of the particle. The velocity of movement produced by electrokinetic force is determined by the relative charge and mass of the individual particle and the fluid encasing it. Movement of a particle can be altered by the type of label that has been attached to the particle, such as a charge/mass tag. Therefore, the electrophoretic velocity of each detectably labeled particle is determined. Based on the determination of the electrophoretic velocity of each detectably labeled particle, individual particles in a sample comprising multiple particles can be distinguished. Any electrophoretic separation technique combined with an immunoassay or nucleic acid hybridization labeling technique can, in principle, be adapted for use in the context of the present invention.

In an additional embodiment, when two or more particles are present, at least one particle may move through at least two interrogation volumes in a direction opposite to that of the other particle.

Preferably, the sample comprises a buffer. While any suitable buffer can be used, the preferable buffer has low fluorescence background, is inert to the detectably labeled particle, can maintain the working pH and is at, or can be combined with suitable reagents to make an ionic strength suitable for electrophoresis. The buffer concentration can be any suitable concentration, such as in the range from 1-200 mM. Preferably, the buffer is selected from the group consisting of Gly-Gly, bicine, tricine, 2-morpholine ethanesulfonic acid (MES), 4-morpholine propanesulfonic acid (MOPS) and 2-amino-2-methyl-1-propanol hydrochloride (AMP). An especially preferred buffer is 2 mM Tris/borate at pH 8.1, but Tris/glycine and Tris/HCl are also acceptable. Preferred ionic strength is at least 50 mM.

For some applications, the buffer desirably further comprises a sieving matrix for use in the embodiment of the method. While any suitable sieving matrix can be used, desirably the sieving matrix has low fluorescence background and can specifically provide size-dependent retardation of the detectably labeled particle relative to other components in the fluid. The sieving matrix can be present in any suitable concentration; from about 0.1% to about 10% is preferred. Any suitable molecular weight can be used; from about 100,000 to about 10 million is preferred. Examples of sieving matrixes include poly(ethylene oxide) (PEO), poly(vinylpyrrolidone) (PVP), linear polyacrylamide and derivatives (LPA), hydroxypropyl methylcellulose (HPMC) and hydroxyethylcellulose (HEC), all of which are soluble in water and have exceptionally low viscosity in dilute concentration (0.3% wt/vol). These polymer solutions are easy to prepare, filter and fill into capillaries. To achieve sieving, the polymers are used at concentrations above their entanglement threshold. Addition of 0.2% LPA (5,000,000-6,000,000 MW) to a Tris/borate buffer enabled discrimination of IgG and a 1.1 kb nucleic acid fragment during a one minute electrophoretic separation (see Example 4 below).

Electrokinetic force can be combined with other motive forces such as pressure, vacuum, surface tension, gravitational force, and centrifugal force to discriminate between particles. In one embodiment, these forces can be chosen for their differential effects on different particles within a sample when two or more particles are present, resulting in at least one particle moving through at least two interrogation volumes with a velocity that differs from the other particle(s). The velocities of the particles can be aligned with the fluid flow or at least one particle can move antiparallel to the fluid flow. In another embodiment, at least one particle has an antiparallel velocity exceeding the velocity of the fluid flow. In another embodiment, at least one particle is in motion perpendicular to the fluid flow. In another embodiment, at least one particle is in motion with a combination of motions that are antiparallel and perpendicular to the fluid flow.

In yet another aspect, the act of moving the particles between a first interrogation volume and a second interrogation volume further comprises subjecting the particles to a separation method selected from the group consisting of capillary gel electrophoresis, micellar electro-kinetic chromatography, isotachophoresis, a magnetic field, an optical field, sorption, and any combination thereof.

One skilled in the art will recognize that capillary gel electrophoresis, micellar electro-kinetic chromatography, isotachophoresis and magnetic field separations are standard biochemical techniques. Use of optical fields for moving, scattering or trapping (as with optical tweezers) particles is described in U.S. Pat. Nos. 6,784,420 and 6,744,038, incorporated herein by reference in their entirety. Optophoresis™ consists of subjecting particles to various optical forces, especially moving optical gradient forces. By moving the light relative to particles, typically through a medium having some degree of viscosity, particles are separated or otherwise characterized based at least in part upon the optical force asserted against the particle and the particle's dielectric constants. Generally, the light sources will be lasers, and the separations are accomplished in capillary or microchannel structures that are compatible with the instrumentation described for the current invention.

### Instrumentation

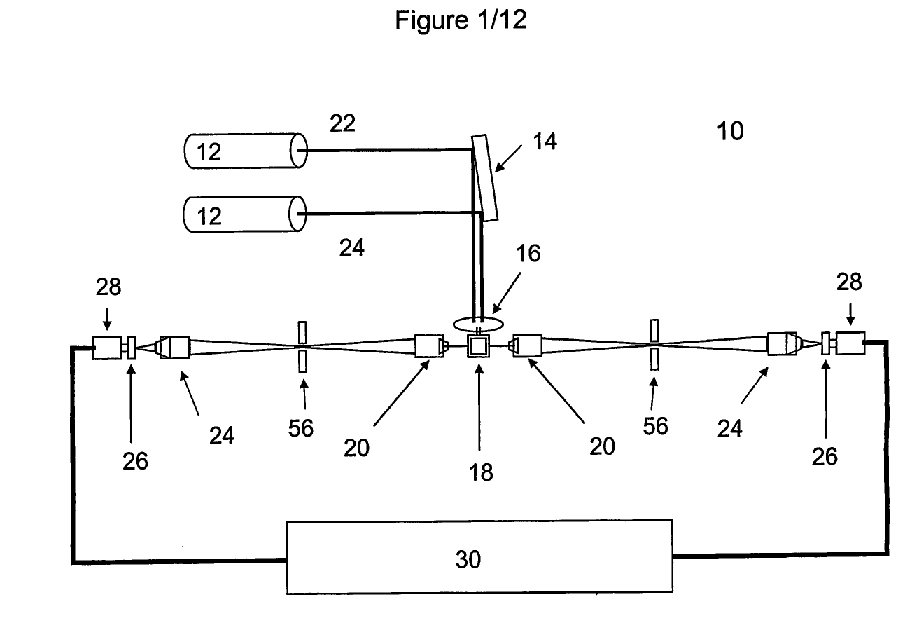

In one embodiment of the invention, an SMD system described in FIG. 1 may be used. As shown in FIG. 1, an analyzer of one embodiment of the present invention is designated in its entirety by the reference numeral 10. The analyzer 10 includes two electromagnetic radiation sources 12, a mirror 14, a lens 16, capillary flow cells 18, two microscope objective lenses 20, two apertures 56, two detector lenses 24, two detector filters 26, two single photon detectors 28, and a processor 30 operatively connected to the detectors.

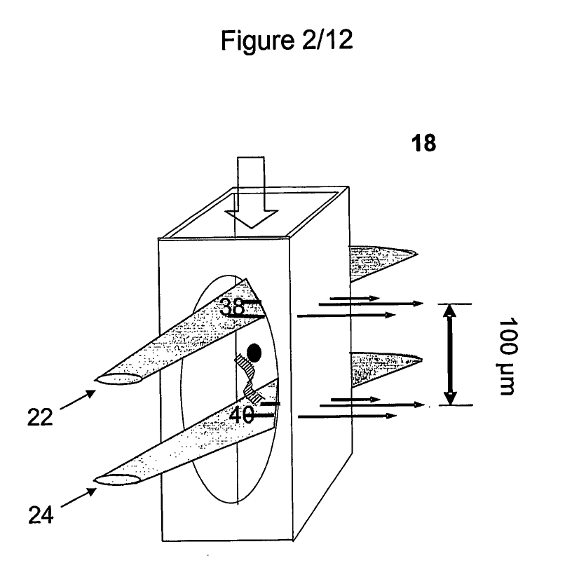

In operation, the radiation sources 12 are aligned so their beams 22, 24 are reflected off a front surface of mirror 14. The lens 16 focuses the beams 22, 24 into two separate interrogation volumes (e.g., interrogation volumes 38, 40 shown in FIG. 2 in the capillary flow cell 18). The microscope objective lenses 20 collect light from sample particles and form images of the beams 22, 24 onto the apertures 56. The apertures 56 block out scattering from walls of the capillary flow cell 18. The detector lenses 24 collect the light passing through the apertures 56 and focus the light onto an active area of the detectors 28 after it passes through the detector filters 26. The detector filters 26 facilitate minimizing noise signals (e.g., scattered light, ambient light) and maximizing the light signal from the particle. The processor 30 processes the light signal from the particle according to the methods described herein. In one embodiment, the microscope objective lenses 20 are high-numerical aperture microscope objectives.

The heart of the system is the glass capillary flow cell of the apparatus 18 shown in FIG. 2. Two laser beams 22, 24 are optically focused about 100 μm apart and perpendicular to the length of the sample-filled capillary tube. The lasers 12 (FIG. 1) are operated at particular wavelengths depending upon the nature of the molecules to be excited. The interrogation volumes 38,40 of the detection system is determined by the cross sectional area of a laser beam 22 or 24 and by the segment of the laser beam selected by the optics that direct light to the detectors. The interrogation volume 38 or 40 is set such that, with an appropriate sample concentration, single particles are present in the interrogation volume during each time interval over which observations are made. When laser beams 22, 24 with Gaussian intensity distributions are employed as excitation sources, the strength of illumination is not uniform across the interrogation volume unless that volume is very small and confined to the center of the laser beam. As a result, particles experience different intensities of excitation and different numbers of photons are emitted depending on whether a particle passed through the beam near the center or the edge. Therefore, a population of identical particles will show a distribution of emission intensities.

Particles are moved through the capillary either in bulk fluid flow, via an electric field applied to the sample, or a combination thereof. Under electrophoretic conditions, like particles move through the tube in lockstep (plug flow). As particles pass through each laser beam, excitation of each fluorescent particle takes place via one-photon excitation. Within a fraction of a second, the excited particle relaxes, emitting a detectable burst of light. The excitation-emission cycle is repeated many times by each particle as it passes through the laser beam allowing the instrument to detect hundreds of particles per second. Photons emitted by fluorescent particles are registered in both detectors with a time delay indicative of the time for the particle to pass from the interrogation volume of one detector to the interrogation volume of the second detector.

Electromagnetic radiation is detected by at least two detectors, at least one detector for each of two interrogation volumes. In one embodiment, electromagnetic emission refers to the release of photons from a particle in response to a stimulus. In the case of fluorescent emission, the stimulus is absorbed light.

For elastic light scattering, the emission is at the same wavelength as the incident light, but has been dispersed by the particle itself. In other cases, the scattered light is of a different wavelength than the incident light. For example, when nano-sized metal colloid particle are illuminated with a standard white light source, the scattering produces intense monochromatic light.

Light is the preferred electromagnetic radiation to detect, particularly light in the ultra-violet, visible, or infrared ranges. The detectors of the instrument are capable of capturing the amplitude and the time segment adjacency of photon bursts from fluorescent particles and converting them to electronic signals. Detection devices such as CCD cameras, Foveon X3® sensors, video input module cameras, and Streak cameras can be used to produce images with contiguous signals. In another embodiment, devices such as a bolometer, a photodiode, a photodiode array, avalanche photodiodes, and photomultipliers can be used. In a preferred embodiment, avalanche photodiodes are used for the very sensitive detection of individual photons. Using specific optics between the interrogation volume and the detector, several distinct characteristics of the emitted electromagnetic radiation can be detected including: emission wavelength, emission intensity, burst size, burst duration, fluorescence lifetime, and fluorescence polarization. A preferred characteristic is emission intensity. Emission intensity is quantitatively dependent on the fluorescence quantum yield of the dye, the excitation source intensity, polarity, and wavelength, and the detection efficiency of the instrument. It is also affected by the components of the solution, including solvents, ions (such as those that determine pH) and the concentration of the dye. Dye intensity can change if the particle is exposed to a light source that causes photo-bleaching. One skilled in the art will recognize that one or more detectors can be configured at each interrogation volume and that the individual detectors may be configured to detect any of the characteristics of the emitted electromagnetic radiation listed above.

The preferred illumination sources are continuous wave lasers for wavelengths of >200-1100 nm. These illumination sources have the advantage of being small, durable and relatively inexpensive. In addition, they generally have the capacity to generate large fluorescent signals. Specific examples of suitable lasers include: lasers of the argon, krypton, helium-neon, helium-cadmium types as well as tunable diode lasers (red to infrared regions), each with the possibility of frequency doubling. The lasers provide continuous illumination with no accessory electronic or mechanical devices such as shutters, to interrupt their illumination. Light emitting diodes (LEDs) are another low-cost, high reliability illumination source. Recent advances in ultra-bright LEDs coupled with dyes with high absorption cross-section and quantum yield, support their applicability to single particle detection. Such lasers could be used alone or in combination with other light sources such as mercury arc lamps, elemental arc lamps, halogen lamps, arc discharges, plasma discharges, light-emitting diodes, or combination of these. The optimal laser intensity depends on the photo bleaching characteristics of the individual dyes and the length of time required to traverse the interrogation volume (including the speed of the particle, the distance between interrogation volumes and the size of the interrogation volumes). To obtain a maximal signal, it is desirable to illuminate the sample at the highest laser intensity that will not overly photo-bleach of the dyes. The preferred laser intensity is one such that no more that 5% of the dyes are bleached by the time the particle has traversed the final interrogation volume.

Alternatively, pulsed lasers can be used as illumination sources. Pulsed lasers together with time-gated detectors can be used for determining the fluorescence lifetime of particles as one option for detection and discrimination. In the case of fluorescent emissions, the photon signal detected depends both on the wavelength spectra of the fluorescent emission and the filters used with the detectors in the instrument. Therefore, particles with different but overlapping emission spectra may appear indistinguishable if the filter range encompasses both spectra.

### Data Analysis

Data analysis may be conducted according to the following stepped embodiment:
1. measuring a first electromagnetic radiation signal emitted by a particle within a first interrogation volume and applying a first analytical filter to the first electromagnetic radiation signal and measuring a second electromagnetic radiation signal emitted by the particle in a second interrogation volume and applying a second analytical filter to the second electromagnetic radiation signal;
2. comparing by cross-correlation the filtered electromagnetic radiation signal emitted by the particle within the first interrogation volume to the filtered electromagnetic radiation signal emitted by the particle within the second interrogation volume; and
3. further applying another analytical filter to the cross-correlation events.
   In a further embodiment, the stepped method may be accomplished according to the following:
1. Detect all electromagnetic radiation signals during a sample measurement period.
2. Subdivide data into arbitrary time segments and determine the background level of electromagnetic radiation over all the time segments (bins) independently for data collected in both detection channels.
3. Set a threshold level above the background level, and apply analytical filters to select signals that have electromagnetic radiation signals above the threshold and form a peak. Peaks are identified independently for data collected in each detection channels. The criteria for the analytical filters fits the criteria known to match the signals of similar particles.
4. Cross-correlating the peaks selected above that occur in channel one (from the first interrogation volume) with peaks in channel two (from the second interrogation volume) over a range of time.
5. Apply analytical filters to the cross-correlated events to select events that match the known characteristics of signal brightness or peak width of the target particles.
6. Plot each selected cross-correlated event and draw a histogram to show the density of the events at each unit of elapsed time.
7. Data sets can be further restricted by observing events that fall within only a portion of the elapsed time range or a portion of the duration of the measurement.

More specifically, the signals detected by each of the first and second detectors are divided into arbitrary, time segments with freely selectable time channel widths. Preferred channel widths (bins) are in the range of 1 μs to 5 ms. The number of signals contained in each segment is then established. In a preferred embodiment, the detected signals are first analyzed to determine the background. The background is determined by averaging the signal over a large number of bins. In one embodiment the average signal is calculated using the entire number of bins in the sample. In a preferred embodiment, a second average is calculated where bins that contain photons 2-3 standard deviations above the original background calculation are eliminated. In other embodiments, the background level is determined from the mean noise level, or the root-mean-square noise. In other cases, a typical noise value or a statistical value is chosen. In the case of single photon counting detectors, the noise is expected to follow a Poisson distribution.

In a preferred embodiment, the detected signals are selected above a threshold prior to cross-correlating the data. A threshold value is determined to discriminate true signals (peaks, bumps, particles) from background. Care must be taken to choose a threshold value such that the number of false positive signals from random background is minimized and the number of true signals that are rejected is minimized. Methods for choosing a threshold value include: arithmetic methods, statistical methods, determining a fixed value above the background level, and calculating a threshold value based on the distribution of the background signal. In a preferred embodiment, the threshold is set at a fixed number of standard deviations above the background level. Assuming a Poisson distribution of the background and using this method, one can estimate the number of false positive signals detected during the experiment.

Analytical filters are applied to signals that are above threshold levels by comparing those signals to signals known to originate from similar particles and only those that match the criteria in terms of the number of photons above the threshold occurring in adjacent time segments are selected. For each signal selected from the first detection channel, a cross-correlation analysis is performed with the signals selected from the second detection channel within a predetermined time range. In this way, an event is discriminated from background based on the presence of correlated signal(s) in at least two detector channels. The elapsed time of the cross-correlated signals provides the transit time between the corresponding detectors and therefore based on the distance between the detectors, the velocity of the particle is determined. A particle can be detected when the elapsed time for the correlation corresponds to a known elapsed time. In other cases, a particle is detected via unknown elapsed time which is determined empirically by repeating the cross-correlation using broader or narrower ranges in the analysis until the optimum conditions for particle detection and discrimination are determined.

In a further embodiment, the cross-correlation analysis can be performed on data from more than two detectors, such as 3, 4, 5, 6, 7, 8 and more detectors that are distinct either in relative location of the interrogation volume or in the wavelength detected. In this case, the cross-correlation analysis can be performed on data from any combination of detectors that are distinct. For example, in a case where three detectors, each detecting a distinct electromagnetic radiation characteristic (R, G & B) are at each of two interrogation volumes (1 & 2), R1 is correlated with R2, G1 is correlated with G2 and B1 is correlated with B2, resulting in elapsed times for particles with characteristic emission detected by the individual detectors. Other combinations of cross-correlation analysis can also be performed, such as overlapping sets where R1 is correlated with G1; R1 is correlated with B1 and G1 is correlated with B1. Results of these cross-correlation analyses would indicate the frequency of double-labeled particles. Different combinations of cross-correlation analyses can be used with one another to distinguish particles based on velocity and electromagnetic characteristic, for example, R1 is correlated to G1 and the combination is correlated with the correlation of R2 and G2. In addition, using multiple cross-correlation analyses will result in more accurate determination of the properties of the individual particles within the mixture.

In a further embodiment, analysis methods are employed wherein cross-correlation analysis is performed on data from detectors in any or all combinations of locations and/or characteristics that are distinct.

For samples where particles are moved at a uniform velocity, cross-correlated signals that have the expected velocity are determined to be events of interest. For samples where particles are moved at different velocities, cross-correlated signals are determined to be events of interest when, at a particular velocity, they have the expected (predetermined) photon burst attributes for that velocity in a particular instrumentation system configuration. Faster moving particles will have fewer bursts of photons in adjacent time segments than slower moving particles.

False cross-correlated events occur when particles do not have the expected velocity due to any one of several reasons: fluorescent impurities in the sample, particles passing through only one interrogation volume during their transit through the capillary or erroneous cross-correlations. Erroneous cross-correlation can result when photons from other particles move closely behind or ahead of the “correct” photon associated with the “correct” particle.

Following cross-correlation, at least one analytical filter is applied to the cross-correlated data that eliminates events that fall outside the known characteristics of the target particles. These filters can be based on electromagnetic characteristics such as fluorescent brightness (intensity), and the width of emission signal above the threshold value (bin number). These filters are different from those applied to the signals before cross-correlation. Events can also be restricted to a certain range of elapsed time that is evaluated or a portion of the time during which the sample is analyzed. More than one filter can be applied to a data set simultaneously.

Filtering is used to determine when a cross-correlated event was generated by a particle (i.e., the emission was of the expected duration, intensity, and/or magnitude for a single particle under these conditions as predetermined). Other characteristics or combinations of characteristics also can be used to detect particle events. In this manner, filtering allows one to detect particles moving at the expected velocity and having the emission characteristics of particles moving at this velocity.

Finally, the computer produces a histogram of velocities that shows a peak for every fluorescent particle present in the sample. When the sample moves in a bulk fluid flow through the capillary, all particles move at the same velocity. When an electric field is applied to the sample, the transit time between the detectors for each particle is dependent upon the particle's characteristic charge, size and shape.

The methods described herein allow particles to be enumerated as they pass individually through the interrogation volumes. The concentration of the sample can be determined from the number of particles counted and the volume of sample passing though the interrogation volume in a known amount of time. In the case where the interrogation volume encompasses the entire cross-section of the sample stream, only the number of particles counted and the volume passing through a cross-section of the sample stream in a known amount of time are needed to calculate the concentration the sample. When the interrogation volume is smaller than the sample stream, the concentration of the particle can be determined by interpolating from a standard curve generated with a control sample of standard concentration. In a further embodiment, the concentration of the particle can be determined by comparing the measured particles to an internal or external particle standard. Knowing the sample dilution, one can calculate the concentration of particles in the starting sample.

### EXAMPLES

Without further elaboration, it is believed that one skilled in the art can, using the preceding description, utilize the present invention to its fullest extent. The following specific examples are offered by way of illustration and not by way of limiting the remaining disclosure.

### Example 1

### Detection of Nucleic Acid Targets Moving at Uniform Rate Using Cross-Correlation and Analytical Filters

1a. Linearized pUC19 was labeled with Alexa Fluor®647 using a ULYSIS® nucleic acid labeling kit (Molecular Probes, Inc., Eugene, Oreg.) according to the manufacturer's instructions. Unbound label was removed and the sample was suspended at 7.5 fM in phosphate buffered saline with 0.01% casein hydrolysate and pumped through the interrogation volumes of the analyzer at 1 μl/min.

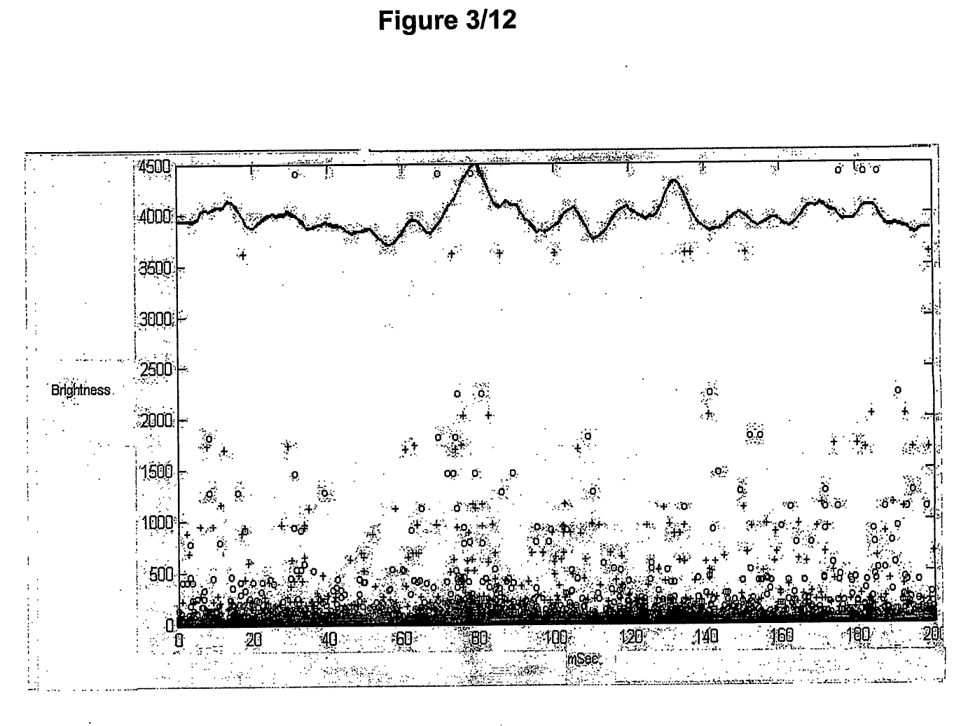

1b. Another sample consisted of a 7.2 kb DNA fragment labeled as above and subjected to electrophoresis at 3000V for 60 seconds in 0.2× TB, 0.01% SDS. Analyzed data is shown in FIG. 3. Panels 3A and 3B show data from 7.5 mM linearized pUC19 moved through the analyzer by pumping. The detected signals were filtered to select those that were greater than two standard deviations above the average background. The filtered signals were cross-correlated and plotted. Dot plots show brightness (y-axis) vs. elapsed time (x-axis) for each individual cross-correlated pair of events, circles representing events originating in channel 1 and pluses representing events originating in channel 2. The solid line is a histogram of dot density. A) Initial cross-correlation of the filtered signals revealed no discernable peaks. B) Applying another analytical filter to the cross-correlation events enabled selection of events with brightness between 15-500 photons that moved as a dominant peak at around 80 ms.

Panels 3C and 3D show data from a 7.2 kb DNA fragment moved through the analyzer by electrophoresis. The detected signals were filtered to select those that were greater than six standard deviations above the average background. The filtered signals were cross-correlated and plotted. Dot plots of time (y-axis) vs. elapsed time (x-axis) for each individual cross-correlated pair of events, circles representing events originating in channel 1 and plusses representing events originating in channel 2. The solid line is a histogram of dot density. C) The shoulder on the peak is composed of events that occurred primarily in the last half of the sample run (dot density is higher near the top of the chart) suggesting a change in the electrophoresis system with time. D) Restricting the data to the first 30 seconds of the run results in a histogram that shows a single peak primarily without the shoulder that was an artifact of changes in the electrophoresis system.

### Example 2

### Using Predetermined Electrophoretic Velocity Ranges to Automatically Detect One of Two Particles in a Sample

An intrinsically fluorescent protein complex, PBXL-3, and a 1.1 kb nucleic acid were used to predetermine characteristic electrophoretic velocity ranges. The nucleic acid was labeled with Alexa Fluor® 647 following the protocol of the ULYSIS® nucleic acid labeling kit (Molecular Probes, Inc., Eugene, Oreg.). The samples were subjected to electrophoresis, and data was analyzed according to the scheme described above, except that analytical filters for brightness and peak width were applied after cross-correlation. The protein complex and nucleic acid were analyzed independently and the characteristic ranges for the peak height, peak width and elapsed time were used to determine windows where each particle was expected to occur (Table 1).

TABLE 1

| | Window 1 | Window 2 |
|---|---|---|
| | (for PBXL3) | (for 1.1 kb nucleic acid) |
| Peak | >150 | <150 |
| Width | >3 | <3 |
| Elapsed Time | 350-500 ms | 250-300 ms |

Using these characteristics, four samples were analyzed and the number of cross-correlated events that occurred in each window was determined (Table 2). These predetermined windows can be used to analyze samples whose content is unknown. If events occur within both windows, the sample consists of a mixture of particles. If events occur in only one window, only one type of particle is present.

TABLE 2

| | Window 1 | Window 2 |
|---|---|---|
| PBXL3 | 59 | 2 |
| Nucleic acid | 3 | 238 |
| Mixture of PBXL3 and nucleic acid | 45 | 191 |
| Buffer blank | 0 | 0 |

### Example 3

### Detection and Discrimination of Particles in a Mixture Moving at Uniform Rates Using Cross-Correlation Analysis and Filtering

An intrinsically fluorescent protein complex, PBXL-3, emits at a high intensity relative to a nucleic acid, linearized pUC19 labeled with Alexa Fluor® 647. The pUC19 DNA was labeled with Alexa Fluor® 647 following the protocol of the ULYSIS® nucleic acid labeling kit (Molecular Probes, Inc., Eugene, Oreg.). Phosphate Buffered Saline (PBS) (10 mM sodium phosphate, 150 mM NaCl, pH 7.2) was supplemented with 0.01% casein hydrolysate (Sigma-Aldrich Corp., St. Louis, Mo.) and used to make dilution series (2.5, 5, 7.5, 10 and 20 fM) of protein alone, nucleic acid alone or mixtures of both. Samples were moved through the analyzer by pumping at 1 μl/min for 4 min.

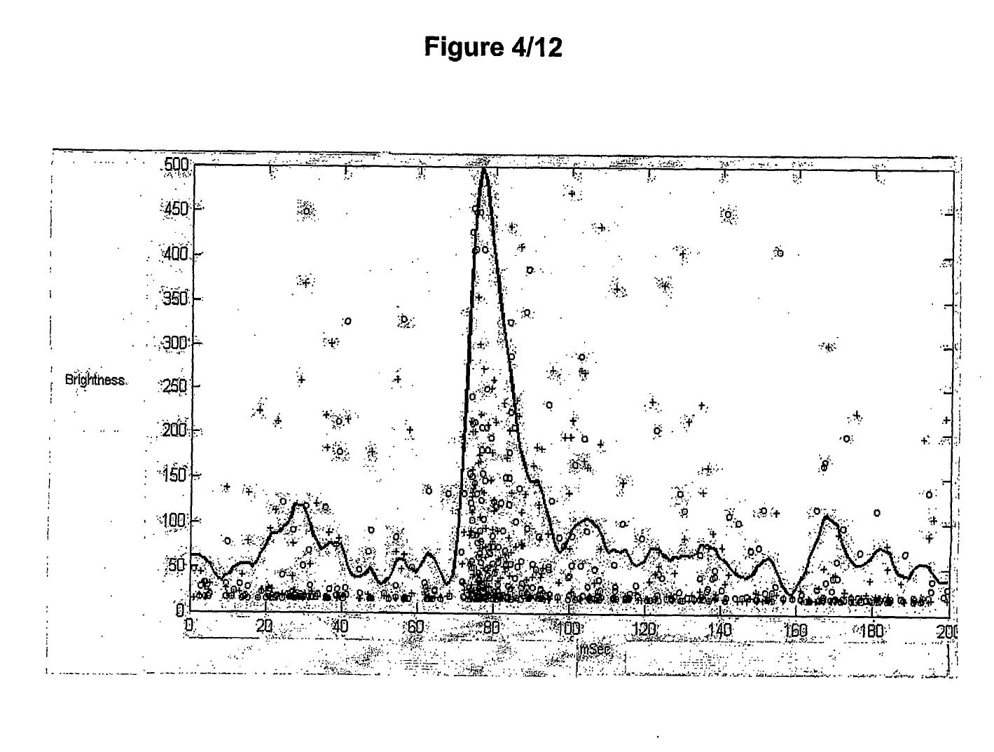

Data was analyzed as described above. The detected signals were filtered to select those that were greater than four standard deviations above the average background. FIG. 4A shows plots of cross-correlated filtered signals for the protein complex and nucleic acid alone. The range of elapsed time was restricted to show only the events within the peaks themselves (see FIG. 4A) and to emphasize the different characteristic fluorescent intensities of the protein complex and the nucleic acid. A brightness level of 500 photons was chosen to separate a bright window of intensity for the protein complex and a dim window of intensity for the nucleic acid. An analytical filter based on brightness of 15-500 for the nucleic acid and 500-9,000 for the protein complex was applied to the data. The number of events identified by these methods was measured for both the protein complex and nucleic acid at series of concentrations. Standard curves were plotted for the protein and nucleic acid using both brightness windows, and the slopes of the curves were determined.

In three different mixtures, the protein complex and nucleic acid were discriminated based on their intensity. The analytical filter for brightness was applied, and the number of molecules detected in the mixtures of PBXL-3 and pUC19 were used to calculate the concentrations of each component based on the slopes of the standard curves. Comparing the measured concentrations for the protein and nucleic acid to the predicted values demonstrates that the concentration of sample components can be determined by comparing the molecules detected in the sample to a standard curve (FIG. 4B).

### Example 4

### Detection and Discrimination of Particles in a Mixture Moving at Different Rates Using Optimized Cross-Correlation Analysis and Filtering

IgG and a 1.1 kb PCR product were both labeled with Alexa Fluor® 647 according to the manufacturer's protocols for proteins and nucleic acids respectively (Molecular Probes, Inc., Eugene, Oreg.). A mixture of 13 fM IgG and 5 fM nucleic acid was suspended in a buffered sieving solution consisting of 18 mM Tris, 18 mM boric acid, pH 8.6 with 0.2% linear polyacrylamide (LPA, 5,000,000-6,000,000 MW), 0.01% sodium dodecyl sulfate and 1 μg/ml each bovine serum albumin, Ficoll®, and polyvinylpyrrolidone. Unbound labels were removed prior to making the mixture and the sample was subjected to electrophoresis at 300 V/cm for one minute to move the molecules through the interrogation volumes of the analyzer.

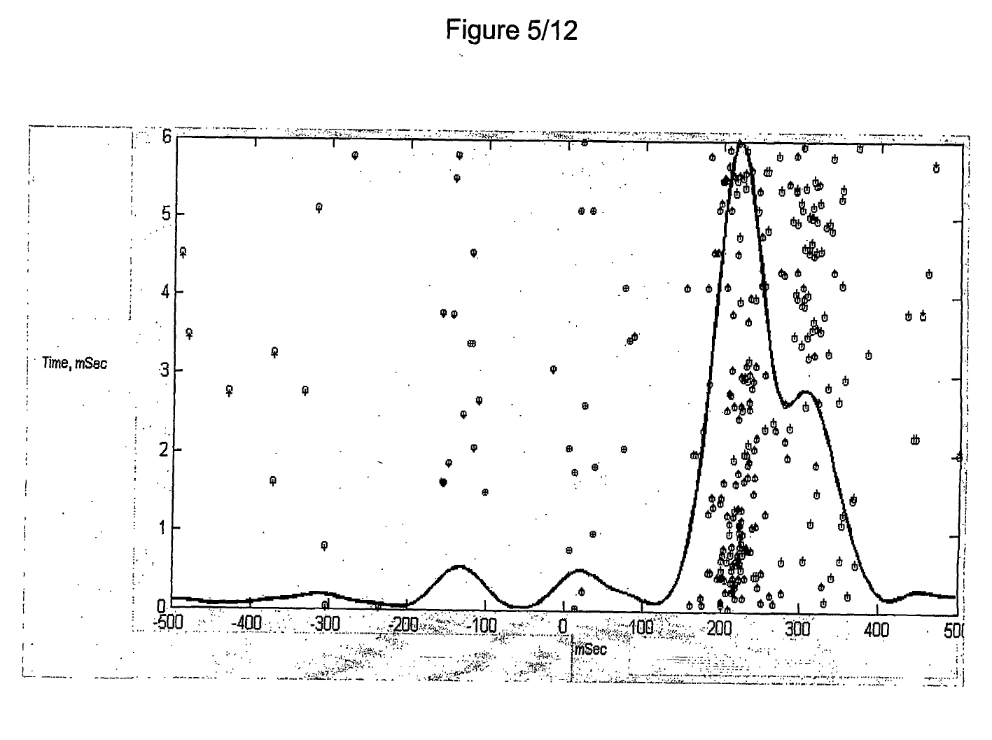

Data were analyzed as described above, except that a series of analytical filters based on peak width (bins) were applied to the cross-correlated events. FIG. 5A shows that with the broadest filter (0-5 bins), peaks for both the protein and nucleic acid are observed. Applying narrower elapsed time filters, selects for the signals of either the protein molecule (FIG. 5B (0-1 bins)) or the nucleic acid molecule (FIG. 3C (1-5 bins)). This demonstrates that the analytical filters can be used to confirm the identity of the molecules in a mixture that were separated by their different velocities.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

What is claimed is:

1. A method for enhancing the analysis of particle detection comprising:
measuring a first electromagnetic radiation signal provided by a particle within a first interrogation volume and optionally applying a first analytical filter to the first electromagnetic radiation signal and measuring a second electromagnetic radiation signal emitted by the particle in a second interrogation volume and optionally applying a second analytical filter to the second electromagnetic radiation signal;
comparing by cross-correlation the electromagnetic radiation signal emitted by the particle within the first interrogation volume to the electromagnetic radiation signal emitted by the particle within the second interrogation volume; and
further applying a third analytical filter to the cross-correlation events;
thereby enhancing the analysis of the particle detection.

2. A method according to claim 1, wherein one of or both the first analytical filter and the second analytical filter are applied.

3. A method according to claim 2, wherein both the first analytical filter and the second analytical filter are applied, and wherein the first analytical filter and the second analytical filter are the same analytical filter.

4. A method according to claim 1, wherein the first and second analytical filters are selected from the group consisting of signals that are greater than a predetermined threshold level, signals within a predetermined number of adjacent time segments, and a combination thereof.

5. A method according to claim 1, wherein applying the third analytical filter comprises detecting a particle characteristic selected from the group consisting of emission intensity, burst size, burst duration, fluorescence lifetime, fluorescence polarization, and any combination thereof.

6. A method according to claim 5, wherein the particle characteristic is provided by one of an intrinsic parameter of the particle or an extrinsic parameter of the particle.

7. A method according to claim 6, wherein the extrinsic parameter is provided by marking the particle with at least one label selected from the group consisting of a dye tag, a light-scattering tag, and any combination thereof.

8. A method according to claim 1, wherein the first analytical filter, the second analytical filter and the third analytical filter are applied before cross-correlating the first electromagnetic radiation signal and second electromagnetic radiation signal.

9. A method according to claim 1, wherein the first and second interrogation volumes are in electromagnetic communication with at least one excitation source selected from the group consisting of a light-emitting diode, a continuous wave laser, and a pulsed laser.

10. A method according to claim 1, wherein the particle is selected from the group consisting of a polypeptide, a polynucleotide, a nanosphere, a microsphere, a dendrimer, a chromosome, a carbohydrate, a virus, a bacterium, a cell, and any combination thereof.

11. A method according to claim 1, wherein the particle is selected from the group consisting of an amino acid, a nucleotide, a lipid, a sugar, a toxin, and any combination thereof.

12. A method according to claim 1, wherein the particle is selected from the group consisting of an aggregate, a complex, an organelle, a micelle, and any combination thereof.

13. A method according to claim 1, further comprising moving a target particle through the first interrogation volume and through the second interrogation volume by a force selected from the group consisting of electro-kinetic force, pressure difference, osmotic difference, ionic difference, gravity, surface tension, centrifugal force, a magnetic field, an optical field, and any combination thereof.

14. A method according to claim 13, wherein the target particle is one of a population of different particles.

15. A method according to claim 14, wherein the target particle is moved through the first interrogation volume and through the second interrogation volume with the population of different particles at a uniform velocity by a force selected from the group consisting of positive pressure, negative pressure, gravity, surface tension, inertial force, centrifugal force, and any combination thereof.

16. A method according to claim 14, wherein the target particle is moved through the first interrogation volume and through the second interrogation volume with the population of different particles at a different velocity by a force selected from the group consisting of electro-kinetic force, centrifugal force, a magnetic force, an optical force, and any combination thereof.

17. A method according to claim 16, wherein the target particle mobility is determined by an intrinsic parameter of the particle or an extrinsic parameter of the particle.

18. A method according to claim 17, wherein the extrinsic parameter of the target particle is provided by a label selected from the group consisting of a charge tag, a mass tag, a charge/mass tag, a magnetic tag, an optical tag, and any combination thereof.

19. A method according to claim 1, wherein the emitted electromagnetic radiation signal is selected from the group consisting of stimulated emission, fluorescence, elastic light scattering, inelastic light scattering, and any combination thereof.

20. A method according to claim 1, wherein the emitted electromagnetic radiation signal passes through an optical band pass filter within an image plane of a detector.

21. A method according to claim 20, wherein the optical band pass filter enables differential detection of emission spectra.

22. A method according to claim 1, wherein the analysis comprises multiple passes through the processes of applying analytical filters and comparing the electromagnetic radiation signal emitted by the particle within the first interrogation volume to the electromagnetic radiation signal emitted by the particle within the second interrogation volume.
